(19) United States
(12) Patent Application Publication
(10) Pub. No.: US 2025/0173988 A1
(43) Pub. Date: May 29, 2025

(54) IMAGE PROCESSING APPARATUS AND METHOD USING IMAGE PROCESSING MODEL, AND TRAINING APPARATUS AND METHOD FOR IMAGE PROCESSING MODEL

(71) Applicant: SAMSUNG ELECTRONICS CO., LTD., Suwon-si (KR)

(72) Inventors: Xiao TANG, Xi'an (CN); Le Hui, Xi'an (CN); Yuchao Dai, Xi'an (CN); Zhicheng Lu, Xi'an (CN); Tianrui Chen, Xi'an (CN); Xiang Guo, Xi'an (CN); Min Yang, Xi'an (CN)

(21) Appl. No.: 18/949,479

(22) Filed: Nov. 15, 2024

(30) Foreign Application Priority Data
Nov. 27, 2023 (CN) 202311544261.5
Sep. 3, 2024 (KR) 10-2024-0119500

(51) Int. Cl. G06T 19/20; G06V 10/774; G06V 10/80; G06V 10/82

(52) U.S. Cl. CPC G06T 19/20; G06V 10/774; G06V 10/806; G06V 10/82; G06T 2210/56; G06T 2219/2016

(57) ABSTRACT

An image processing apparatus and method using an image processing model, and a training apparatus and method for the image processing model are provided. The image processing apparatus includes a memory including instructions and a processor configured to execute the instructions, wherein, when the instructions are executed by the processor, the processor is configured to determine normative attribute information and structural feature information of a normative space of point clouds included in a plurality of images, transform the normative attribute information into time domain attribute information of a time-domain space, based on the structural feature information and a transformation model that is based on a neural network, and generate a rendered image for the plurality of images, based on the time domain attribute information.

### CROSS-REFERENCE TO RELATED APPLICATION(S)

This application is based on and claims priority from Chinese Patent Application No. 202311544261.5, filed on Nov. 17, 2023, in the China National Intellectual Property Administration, and Korean Patent Application No. 10-2024-0119500, filed on Sep. 3, 2024, in the Korean Intellectual Property Office, the entire disclosures of which are incorporated herein by reference for all purposes.

### BACKGROUND

### 1. Field

Methods and apparatuses consistent with example embodiments relate to an image processing apparatus and an image processing method using an image processing model and to a training apparatus and a training method for an image processing model.

### 2. Description of the Related Art

The art of synthesizing a realistic image and a video is central to image processing technology (e.g., computer graphics technology). New viewpoint synthesis technology related to image processing technology is technology that renders an image of a new viewpoint corresponding to a scene of an input image set, based on a camera position corresponding to the input image set and a new camera position. Existing new viewpoint image synthesis technologies typically use a rendering algorithm that utilizes technology such as rasterization and ray tracing to synthesize images. Recently, differentiable rendering technology or neural rendering technology has emerged as new viewpoint image synthesis technology. Neural rendering technology, represented by neural radiance fields (NeRF), may synthesize images captured from a real world by using classical computer graphics and machine learning.

### SUMMARY

One or more example embodiments may address at least the above problems and/or disadvantages and other disadvantages not described above. Also, the example embodiments are not required to overcome the disadvantages described above, and an embodiment may not overcome any of the problems described above.

According to an aspect of an example embodiment, there is provided an image processing apparatus including: a memory configured to store instructions; and a processor configured to execute the instructions, wherein, by executing the instructions, the processor is configured to: determine a normative attribute information and a structural feature information of a normative space of point clouds included in a plurality of images; transform the normative attribute information into a time domain attribute information of a time-domain space, based on the structural feature information and a transformation model, the transformation model being based on a neural network; and generate a rendered image for the plurality of images, based on the time domain attribute information.

The processor may be further configured to, in determining the normative attribute information: determine a normative attribute information of a normative space of three-dimensional (3D) Gaussian points included in a 3D Gaussian point set corresponding to a point cloud, and at least one of the normative attribute information or the time domain attribute information may include at least one of a position information, a rotation information, or a size information of each 3D Gaussian point of the 3D Gaussian points.

The processor may be further configured to, in determining the structural feature information: obtain, for each 3D Gaussian point, a structural feature information of a 3D Gaussian point by extracting features of the 3D Gaussian point based on the position information of the 3D Gaussian point and fusing the extracted features; and determine a time domain attribute information of each 3D Gaussian point by performing a feature decoding based on the transformation model, the structural feature information of each 3D Gaussian point, and the normative attribute information.

The processor may be configured to, in obtaining the structural feature information of the 3D Gaussian point: obtain structural information of a voxel by extracting a grid feature for the 3D Gaussian point using the position information of the 3D Gaussian point and a voxel feature extraction model; obtain point feature information of the 3D Gaussian point by extracting the features of the 3D Gaussian point using the position information of the 3D Gaussian point and a first neural network model; and obtain the structural feature information of the 3D Gaussian point by fusing the extracted features using the structural information of the voxel, the point feature information of the 3D Gaussian point, and a second neural network model.

The processor may be configured to, in determining the time domain attribute information of each 3D Gaussian point: determine a time-based change attribute information for each 3D Gaussian point by performing a Gaussian transformation on the normative attribute information using the structural feature information and the transformation model; and determine the time domain attribute information based on time for each 3D Gaussian point, based on the normative attribute information and the time-based change attribute information of each 3D Gaussian point, wherein the time-based change attribute information includes: at least one of a position change information, a rotation change information, or a size change information of each 3D Gaussian point.

The plurality of images may include two or more images among at least one of images captured at different times or images captured at different locations.

According to an aspect of an example embodiment, there is provided a training apparatus including: a memory configured to store instructions; and a processor configured to execute the instructions, wherein the processor, by executing the instructions, is configured to: determine a normative attribute information and a structural feature information of a normative space of point clouds included in a plurality of training images; transform the normative attribute information into a time domain attribute information of a time-domain space, based on the structural feature information and a transformation model, the transformation model being based on a neural network; generate a rendered image for the plurality of training images, based on the time domain attribute information; determine a loss based on the generated rendered image and a training image, among the plurality of training images, corresponding to the rendered image; and train the transformation model by adjusting a parameter of the transformation model based on the determined loss.

The processor may be further configured to: determine gradient information of a three-dimensional (3D) Gaussian point of a 3D Gaussian point set corresponding to a point cloud; and determine whether to change a number of 3D Gaussian points based on the time domain attribute information and the gradient information.

The processor may be further configured to: determine normative attribute information of a normative space of 3D Gaussian points included in the 3D Gaussian point set corresponding to the point cloud, and at least one of the normative attribute information or the time domain attribute information may include at least one of a position information, a rotation information, or a size information of each 3D Gaussian point.

According to an aspect of an example embodiment, there is provided an image processing method performed by an image processing apparatus, the image processing method including: obtaining a plurality of images; determining a normative attribute information and a structural feature information of a normative space of point clouds included in the plurality of images; transforming the normative attribute information into a time domain attribute information of a time-domain space, based on the structural feature information and a transformation model, the transformation model being based on a neural network; and generating a rendered image for the plurality of images, based on the time domain attribute information.

The determining the normative attribute information and the structural feature information may include: determining a normative attribute information of a normative space of three-dimensional (3D) Gaussian points of a 3D Gaussian point set corresponding to a point cloud, and at least one of the normative attribute information or the time domain attribute information may include at least one of a position information, a rotation information, or size information of each 3D Gaussian point.

The determining the normative attribute information and the structural feature information may include: obtaining, for each 3D Gaussian point, structural feature information of a 3D Gaussian point by extracting features of the 3D Gaussian point based on the position information of the 3D Gaussian point and fusing the extracted features, and the transforming the time domain attribute information may include: determining a time domain attribute information of each 3D Gaussian point by performing feature decoding based on the transformation model, the structural feature information of each 3D Gaussian point, and the normative attribute information.

The obtaining the structural feature information may include: obtaining structural information of a voxel by extracting a grid feature for the 3D Gaussian point using the position information of the 3D Gaussian point and a voxel feature extraction model; obtaining point feature information of the 3D Gaussian point by extracting the feature of the 3D Gaussian point using the position information of the 3D Gaussian point and a first neural network model; and obtaining the structural feature information of the 3D Gaussian point by fusing the extracted features using the structural information of the voxel, the point feature information of the 3D Gaussian point, and a second neural network model.

The determining the time domain attribute information may include: determining a time-based change attribute information for each 3D Gaussian point by performing a Gaussian transformation on the normative attribute information using the structural feature information and the transformation model; and determining the time domain attribute information based on time for each 3D Gaussian point, based on the normative attribute information and the time-based change attribute information of each 3D Gaussian point, and the time-based change attribute information may include at least one of a position change information, a rotation change information, or a size change information of each 3D Gaussian point.

The plurality of images may include two or more images among at least one of images captured at different times or images captured at different locations.

According to an aspect of an example embodiment, there is provided a training method performed by a training apparatus, the training method including: obtaining a plurality of training images; determining a normative attribute information and a structural feature information of a normative space of point clouds included in the plurality of training images; transforming the normative attribute information into a time domain attribute information of a time-domain space, based on the structural feature information and a transformation model, the transformation model being based on a neural network; generating a rendered image for the plurality of training images, based on the time domain attribute information; determining a loss based on the generated rendered image and a training image, among the plurality of training images, corresponding to the rendered image; and training the transformation model by adjusting a parameter of the transformation model based on the determined loss.

The training may further include: determining gradient information of a three-dimensional (3D) Gaussian point of a 3D Gaussian point set corresponding to the point clouds; and determining whether to perform a density control operation, which changes a number of 3D Gaussian points, based on the time domain attribute information and the gradient information.

The determining the time domain attribute information may include: determining a normative attribute information of a normative space of 3D Gaussian points of a 3D Gaussian point set corresponding to a point cloud, and at least one of the normative attribute information or the time domain attribute information may include at least one of a position information, a rotation information, or a size information of each 3D Gaussian point.

The plurality of training images may include two or more images among at least one of images captured at different times or images captured at different locations.

According to an aspect of an example embodiment, there is provided a non-transitory computer-readable storage medium storing instructions that, when executed by a processor, cause the processor to perform the above-described image processing method.

Additional aspects of embodiments will be set forth in part in the description which follows and, in part, will be apparent from the description, or may be learned by practice of the disclosure.

### BRIEF DESCRIPTION OF THE DRAWINGS

The above and/or other aspects will be more apparent by describing certain example embodiments with reference to the accompanying drawings, in which:

FIG. 1 is a flowchart illustrating an image processing method according to an example embodiment;

FIG. 2 is a diagram illustrating a generation of a rendered image by an image processing method, according to an example embodiment;

FIG. 3 is a diagram illustrating a voxel feature extraction model according to an example embodiment;

FIG. 4 is a diagram illustrating a transformation model according to an example embodiment;

FIG. 5 is a block diagram illustrating an image processing apparatus according to an example embodiment;

FIG. 6 is a block diagram illustrating an image processing apparatus according to an example embodiment;

FIG. 7 is a flowchart illustrating a training method for training a transformation model, according to an example embodiment;

FIG. 8 is a block diagram illustrating a training apparatus according to an example embodiment; and

FIG. 9 is a block diagram illustrating a training apparatus according to an example embodiment.

### DETAILED DESCRIPTION

The following structural or functional description of examples is provided as an example only and various alterations and modifications may be made to the examples. Thus, an actual form of implementation is not construed as limited to the examples described herein and should be understood to include all changes, equivalents, and replacements within the idea and the technical scope of the disclosure.

Although terms such as first, second, and the like are used to describe various components, the components are not limited to the terms. These terms should be used only to distinguish one component from another component. For example, a “first” component may be referred to as a “second” component, and similarly, the “second” component may also be referred to as the “first” component.

It should be noted that when one component is described as being “connected,” “coupled,” or “joined” to another component, the first component may be directly connected, coupled, or joined to the second component, or a third component may be “connected,” “coupled,” or “joined” between the first and second components.

The singular forms “a,” “an,” and “the” are intended to include the plural forms as well, unless the context clearly indicates otherwise. As used herein, each of “A or B,” “at least one of A and B,” “at least one of A or B,” “A, B, or C,” “at least one of A, B, and C,” “at least one of A, B, or C,” “one or a combination or two or more of A, B, and C,” and the like may include any one of the items alone listed together in the corresponding one of the phrases, or any of possible combinations thereof. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the examples are described in detail with reference to the accompanying drawings. When describing the examples with reference to the accompanying drawings, like reference numerals refer to like components and a repeated description related thereto is omitted.

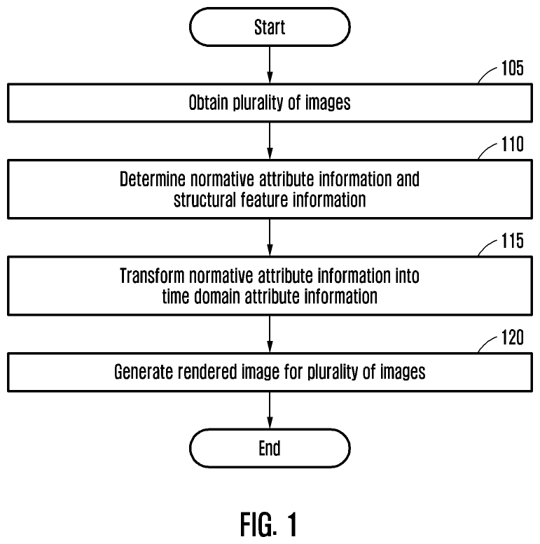

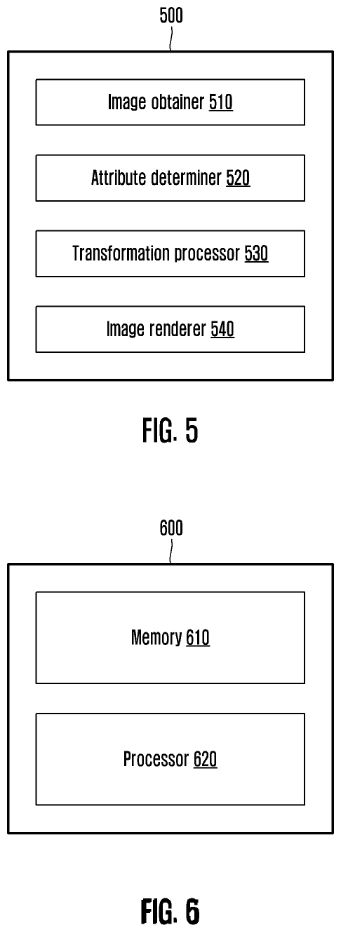

FIG. 1 is a flowchart illustrating an image processing method according to an example embodiment. Operations of the image processing method may be performed by an image processing apparatus (e.g., an image processing apparatus 500 of FIG. 5) according to an example embodiment.

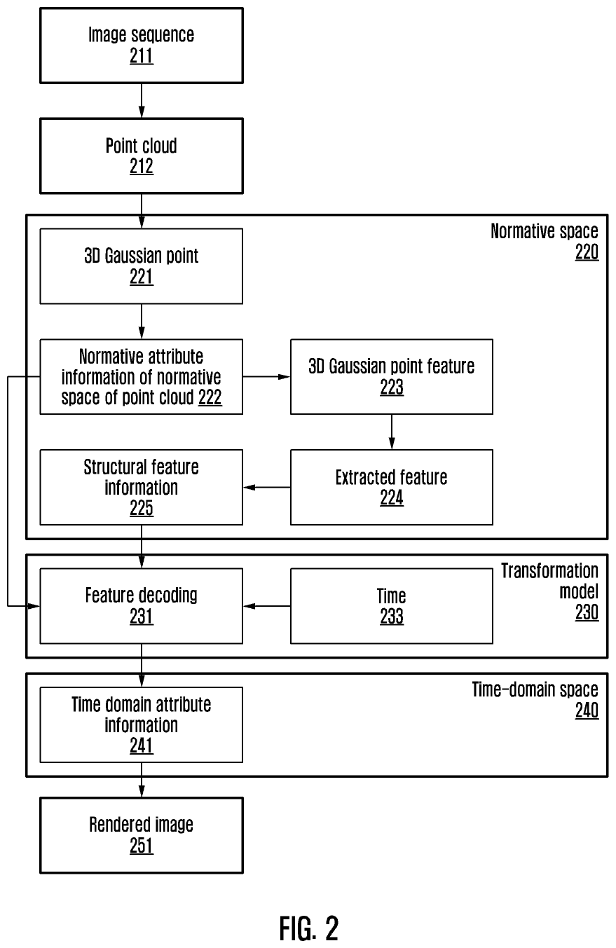

In operation 105, the image processing apparatus may obtain a plurality of images. The image processing apparatus may obtain the plurality of images from an input image sequence (e.g., an image sequence 211 of FIG. 2).

In operation 110, the image processing apparatus may determine normative attribute information and structural feature information. The image processing apparatus may determine the normative attribute information and the structural feature information of a normative space of point clouds included in the plurality of images. For example, the image processing apparatus may obtain structural information of a voxel by extracting a grid feature for a three-dimensional (3D) Gaussian point using position information of each 3D Gaussian point and a voxel feature extraction model. The image processing apparatus may obtain point feature information of the 3D Gaussian point by extracting a feature for each 3D Gaussian point using the position information of each 3D Gaussian point and a first neural network model. The image processing apparatus may obtain structural feature information of each 3D Gaussian point by fusing extracted features of 3D Gaussian points included in the voxel using the structural information of the voxel, the point feature information of the 3D Gaussian point, and a second neural network model.

A point cloud may represent a set of spatial coordinates for sampled points on a surface of an object in an image. The point cloud may represent a feature about spatial distribution of a target in a referenced spatial system and a feature about a surface of the target. An initial point cloud included in an image may be determined based on a structure from motion (SFM) algorithm or may be determined through random initialization.

The image processing apparatus may determine the normative attribute information of the normative space of 3D Gaussian points included in a 3D Gaussian point set corresponding to the point clouds. At least one of the normative attribute information and time domain attribute information may include at least one of position information, rotation information, and size information of each 3D Gaussian point and may be used for image rendering.

The position information may be represented as position coordinates (x₀, y₀, z₀) in the normative space. However, embodiments are not limited thereto. x₀ denotes a coordinate of a position along an x-axis, y₀ denotes a coordinate of a position along a y-axis, and z₀ denotes a coordinate of a position along a z-axis. The rotation information may be represented as 3D rotation coordinates R(a₁, a₂) parameterized by six-dimensional (6D) parameters. However, embodiments are not limited thereto. a₁ and a₂ may each be a row vector of three rows, and the 3D rotation coordinates R(a₁, a₂) may be represented with a total of six variables. The six variables included in the 3D rotation coordinates may be transformed into a rotation group SO(3) rotation matrix. A rotation group matrix will be described in more detail with reference to Equations 5 to 7. The size information may be represented as a size s(sₓ, s_{y}, s_{z}) of the 3D Gaussian points. However, embodiments are not limited thereto. sₓ may denote a size of a direction with respect to the x-axis, s_{y} may denote a size of a direction with respect to the y-axis, and s_{z} may denote a size of a direction with respect to the z-axis.

The normative attribute information may include at least one of position information, rotation information, and size information, and may further include density information and color information. For example, the normative attribute information may further include density information represented as density d(o) and color information represented as color values RGB(r, g, b) in a green, red, and blue (GRB) format. However, embodiments are not limited thereto.

The image processing apparatus may determine the normative attribute information in the normative space of each 3D Gaussian point in the 3D Gaussian point set corresponding to the point clouds by assigning a value to the attribute information of each 3D Gaussian point in the point clouds or the 3D Gaussian point set corresponding to the point clouds. For example, the image processing apparatus may randomly assign a value to the attribute information of the point clouds after initializing the attribute information of the point clouds, or may assign a value to the attribute information of the point clouds by inheriting previously stored information or subsequent feedback on image processing. As in the embodiment described above, the attribute information of the point clouds (including the normative attribute information of the 3D Gaussian point) may be learned, may also be randomly determined during initialization, and may be continuously tuned through learning.

Since point cloud data of the point clouds may include a structural characteristic (e.g., a characteristic related to position information), the image processing apparatus may extract the structural feature information related to the structural characteristic from the point clouds. For example, the image processing apparatus may obtain the structural feature information of each 3D Gaussian point by extracting features of the 3D Gaussian point based on the position information of each 3D Gaussian point and fusing the extracted features.

In operation 115, the image processing apparatus may transform the normative attribute information into the time domain attribute information. The image processing apparatus may transform the normative attribute information into the time domain attribute information of a time-domain space, based on the structural feature information and a transformation model that is based on a neural network. For example, the image processing apparatus may determine the time domain attribute information of each 3D Gaussian point by performing feature decoding based on the transformation model, the structural feature information of each 3D Gaussian point, and the normative attribute information. The image processing apparatus may, by using the transformation model (or a transformation field), transform the normative attribute information of the normative space into the time domain attribute information of the time-domain space by introducing a time variable t. The time domain attribute information may include at least one of position information, rotation information, and size information, similar to the normative attribute information, and may further include density information and color information. Hereinafter, the description of the position information, the rotation information, the size information, the density information, and the color information that may be included in the time domain attribute information may be the same as the description of the position information, the rotation information, the size information, the density information, and the color information that may be included in the normative attribute information, and any repeated description thereof may be omitted. The image processing apparatus may determine the time domain attribute information of each 3D Gaussian point by performing feature decoding based on the transformation model, the structural feature information of each 3D Gaussian point, and the normative attribute information.

In operation 120, the image processing apparatus may generate a rendered image for a plurality of images.

The image processing apparatus may generate the rendered image for the plurality of images, based on the time domain attribute information. The image processing apparatus may generate the rendered image through micro-rasterization that is based on the time domain attribute information. For example, when attribute information of a specific time domain related to a 3D Gaussian point is determined, the image processing apparatus may determine attribute information of the 3D Gaussian point for a specific time point (e.g., a to time point). The image processing apparatus may generate a two-dimensional (2D) rendered image by using attribute information (e.g., at least one of position information, size information, rotation information, color information, or density information) and the 3D Gaussian point through micro-rasterization.

The image processing apparatus may generate a rendered image for an arbitrary position at an arbitrary time point, based on a plurality of input images, by generating the rendered image for the plurality of images based on time domain attribute information. Thus, the image processing apparatus may more effectively synthesize an image of a new viewpoint in a dynamic scene. In addition, since the image processing apparatus may generate a rendered image based on time-related information instead of storing image data for each time step, storage resources may be saved and unnecessary storage overhead may be prevented.

FIG. 2 is a diagram illustrating a generation of a rendered image by an image processing method, according to an example embodiment.

Referring to FIG. 2, the image processing apparatus may obtain a plurality of images. The plurality of images may include the image sequence 211 according to time. For example, the plurality of images may include the image sequence 211 including a moving person and/or a moving object. The image processing apparatus may obtain an image by receiving image data via communication, capturing an image via an image capture apparatus (e.g., a camera, a camcorder, and/or the like), and/or reading an image from a storage device (e.g., a memory). When obtaining video data, the image processing apparatus may obtain a plurality of input images from the video at regular intervals. The image processing apparatus may determine a plurality of video frames at a defined frame interval from a plurality of video frames of the video data and obtain each of the determined plurality of video frames as an input image.

The plurality of images may include at least one of images captured at different times and images captured at different locations. For example, the plurality of images may be a plurality of monocular images and may be images captured by a single video or image capture apparatus. The plurality of monocular images may be images captured at different times using a single video or image capture apparatus or may be a plurality of consecutive images from a dynamic scene. However, embodiments are not limited thereto. In addition, a type of the plurality of images may include, but is not limited to, a red, green, and blue (RGB) format image.

The image processing apparatus may determine structural feature information 225 in a normative space of a point cloud 212 of a plurality of images. The image processing apparatus may obtain the structural feature information 225 of each 3D Gaussian point 221 by extracting a feature of a corresponding 3D Gaussian point 221 based on position information of the corresponding 3D Gaussian point 221 and fusing extracted features 224. The image processing apparatus may determine normative attribute information 222 of the normative space of the point cloud 212, based on the point cloud 212 and/or the 3D Gaussian point 221, and determine a 3D Gaussian point feature 223 by using the normative attribute information 222 of the normative space of the point cloud 212.

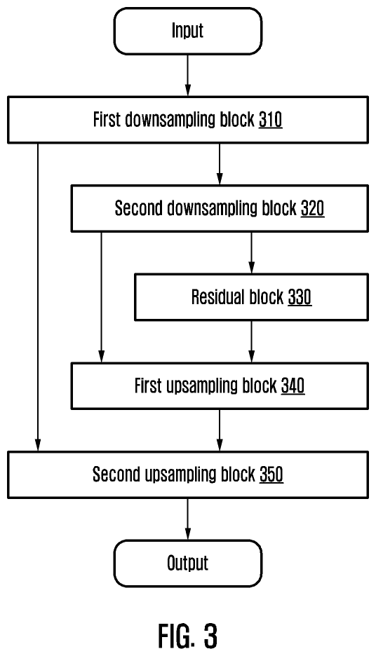

For example, for each 3D Gaussian point 221, the image processing apparatus may obtain structural information of a voxel by extracting a grid feature for the 3D Gaussian point 221 using the position information of the 3D Gaussian point 221 and a voxel feature extraction model, obtain point feature information of the 3D Gaussian point 221 by extracting a feature for the 3D Gaussian point 221 by using the position information of the 3D Gaussian point 221 and a first neural network model, and obtain structural feature information 225 of the 3D Gaussian point 221 by fusing features using the structural information of the voxel, the point feature information of the 3D Gaussian point 221, and a second neural network model. The obtaining of the structural feature information 225 by the image processing apparatus will be described in more detail with reference to FIG. 3.

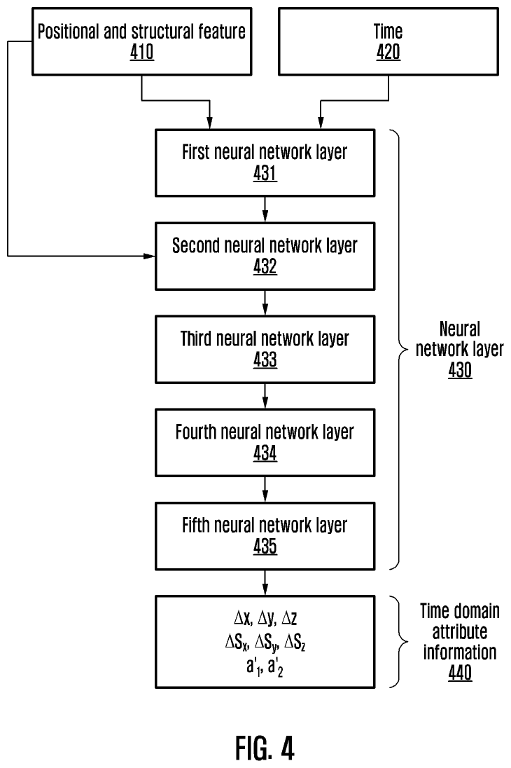

The image processing apparatus may transform the normative attribute information 222 into time domain attribute information 241 of a time-domain space 240, based on the structural feature information 225 and a transformation model 230 that is based on a neural network. The image processing apparatus may transform, by using the transformation model 230, the structural feature information 225 into the time domain attribute information 241 by performing feature decoding 231 based on a time 233. For example, the image processing apparatus may obtain the time domain attribute information 241 in the time-domain space 240 by performing feature decoding 231 on the structural feature information 225 and the determined normative attribute information 222 in which features are fused through time embedding. The image processing apparatus may determine time-based change attribute information for each 3D Gaussian point 221 by performing a Gaussian transformation on the normative attribute information 222 using the structural feature information 225 and the transformation model 230, and may determine the time domain attribute information 241 based on time for each 3D Gaussian point 221, based on the normative attribute information 222 of each 3D Gaussian point 221 and the time-based change attribute information. The time-based change attribute information may include at least one of position change information, rotation change information, or size change information of each 3D Gaussian point 221. The image processing apparatus may determine the time-based change attribute information (e.g., position change information (Δx, Δy, Δz), rotation change information (a₁′, a₂′), and size change information (Δsx, Δsy, Δsz)) of each 3D Gaussian point 221 by performing the feature decoding 231 (e.g., the Gaussian transform) on the normative attribute information 222 using a third neural network model (e.g., a multilayer perceptron (MLP)) based on the structural feature information 225 of each 3D Gaussian point 221. The obtaining of the time domain attribute information by performing the feature decoding 231 using the transformation model 230 will be described in more detail with reference to FIG. 4. The image processing apparatus may generate a rendered image 251 based on the time domain attribute information 241.

FIG. 3 is a diagram illustrating a voxel feature extraction model according to an example embodiment.

A voxel feature extraction model (e.g., U-Net) may extract a voxel feature by extracting a feature of a 3D Gaussian point from position information of each 3D Gaussian point. The 3D Gaussian point may be included in a single voxel (or a mesh).

An input to the voxel feature extraction model may be an initial voxel coordinate determined based on the position information of each 3D Gaussian point, and an output of the voxel feature extraction model may be structural information (e.g., the voxel feature) of the voxel. The input to the voxel feature extraction model may be a voxelized voxel coordinate determined based on position information of a point cloud and/or a 3D Gaussian point computed by sparse convolution based on a U-Net structure to output the structural information (e.g., the voxel feature) of the voxel. The point cloud may have a large number of points, and when a convolution computation is performed on all of the points, a large number of computational resources may be consumed. The voxel feature extraction model may reduce computational resources consumed by performing a calculation on the point cloud based on sparse convolution. Using sparse convolution, an empty region in a space in which no points exist may be skipped, and the space may be divided into multiple grids. Dimensionality of the output may be reduced by using a grid coordinate (e.g., a voxel coordinate) as an input, for which points included in a same grid may be treated as one point, and outputting a feature of each grid.

Since the voxel feature extraction model having a U-Net structure may be based on sparse convolution, and a parameter input to the voxel feature extraction model may be a voxelized voxel coordinate, the output of the sparse convolution may include neighborhood information of the point, and the output voxel feature may be treated as common structural information (e.g., a structural feature) of one or more points in the voxel.

Referring to FIG. 3, the voxel feature extraction model may include a first downsampling block 310, a second downsampling block 320, a residual block 330, a first upsampling block 340, and a second upsampling block 350. The voxel feature extraction model may include five layers as shown above, but is not limited thereto.

Blocks of the voxel feature extraction model may be connected to each other. The first downsampling block 310 may be connected to the second downsampling block 320. When an input is provided to the first downsampling block 310, the first downsampling block 310 may provide an output for the input to the second downsampling block 320.

The first upsampling block 340 may be connected to the second upsampling block 350. An output of the residual block 330 may be input to the first upsampling block 340, or an output of the second downsampling block 320 may be input to the first upsampling block 340 through a skip connection. An output of the first upsampling block 340 may be an input to the second upsampling block 350. An output of the second upsampling block 350 may be the output of the voxel feature extraction model.

The output of the residual block 330 may be provided to the upsampling block together with the output of the second downsampling block 320 that skip the residual block 330. For example, the output of the second downsampling block 320 may be an input to the residual block 330 and an input to the first upsampling block 340, and the output of the residual block 330 may be an input to the first upsampling block 340 together with the output of the second downsampling block 320.

A convolution kernel size of each block may be 3×3×3, a stride size of the first downsampling block 310, the second downsampling block 320, the first upsampling block 340, and the second upsampling block 350 may each be 2, a stride size of the residual block 330 may be 1, a number of output channels of the first downsampling block 310 and the first upsampling block 340 may each be 64, a number of output channels of the second downsampling block 320 and the residual block 330 may each be 128, and a number of output channels of the second upsampling block 350 may be 32. When an input has a kernel size of 5×5×5, a stride size of 1, and a number of output channels of 32, an output may have a kernel size of 1×1×1, a stride size of 1, and a number of output channels of 32.

The second downsampling block 320 and the first upsampling block 340 may be connected to each other through a skip connection. A skip connection may be present between layers, and a computational capability of the voxel feature extraction model may be improved through the skip connection.

The voxel feature extraction model may include two upsampling blocks, two downsampling blocks, and one residual block. However, embodiments are not limited thereto. The voxel feature extraction model may include one or more upsampling blocks, one or more downsampling blocks, and one or more residual blocks. The voxel feature extraction model may include skip connections. However, embodiments are not limited thereto. The voxel feature extraction model may not have skip connections or other connections, and the skip connection is not limited to the connection method of FIG. 3.

The voxel feature extraction model may obtain point feature information of the 3D Gaussian point by extracting the feature of each 3D Gaussian point using a first neural network model (e.g., an MLP) that uses the position information of each 3D Gaussian point as an input. The input to the first neural network model may be the position information of each 3D Gaussian point, and an output of the first neural network model may be the point feature information (e.g., an attribute of the point itself represented with a point vector) of each 3D Gaussian point. For example, the input to the first neural network model may be a 3D vector related to the position information of the 3D Gaussian point, and the output of the first neural network model may be point feature information represented with a 64-dimensional vector related to each 3D Gaussian point.

The neural network model may be an MLP. The neural network model may include a plurality of neural network layers. Each layer included in the plurality of neural network layers may include a plurality of weights and biases as network parameters. An intermediate neural network layer may perform a neural network calculation through a calculation between a calculation result of a previous layer, the plurality of weights, and the biases and may provide a calculation result to a next layer. The network parameters may be adjusted and/or determined through learning.

For example, a neural network may include a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q-network, but embodiments are not limited thereto. In addition, the neural network model may be implemented as another neural network model. However, embodiments are not limited thereto.

The first neural network model may extract unique point feature information (e.g., an attribute of the point itself) from each 3D Gaussian point of a point cloud or a 3D Gaussian point set corresponding to the point cloud. The features of each 3D Gaussian point extracted by the first neural network model may be same as or different from each other, while a structural feature output by a voxel feature model may be a feature related to a common structure of points located in a same voxel. To utilize structural characteristics of the point cloud, the structural information of the 3D Gaussian point and the point feature information of the 3D Gaussian point may be used together.

A second neural network model may obtain structural feature information of the 3D Gaussian point, based on structural information of a voxel determined by the voxel feature extraction model and the point feature information of the 3D Gaussian point obtained from the first neural network model.

The second neural network model (e.g., an MLP) may obtain the structural feature information of the 3D Gaussian point through fusing features based on the structural information of the voxel and the point feature information of the 3D Gaussian point. The structural information of the voxel may be stitched with the point feature information of the 3D Gaussian point, and a stitching result may be input to the second neural network model (e.g., an MLP). The second neural network model into which the stitching result is input may output structural feature information of the fusion, and the fused structural feature information may be used in decoding processing.

An input to the second neural network model may be the stitching result of the structural information of the voxel and the point feature information of the corresponding 3D Gaussian point, and the output of the second neural network model may be the structural feature information of the corresponding 3D Gaussian point. Feature fusion processing may also be implemented by another feature fusion method and is not limited to the description herein.

By fusing an output of the voxel feature extraction model (e.g., feature information of a voxel) and the output of the first neural network model (e.g., the point feature information of the 3D Gaussian point), the structural feature information including both the unique feature of each 3D Gaussian point and the structural feature (e.g., a geometric feature) within the voxel may be obtained, and the structural feature information may be used as more accurate input data to the transformation model.

Through the process described above, normative attribute information and structural feature information of the 3D Gaussian point or the point cloud in a normative space may be determined. In addition, by introducing a time variable t, using the transformation model, information in a time-domain space (e.g., time domain attribute information) may be obtained through transformation of the normative attribute information and the structural feature information based on time. Hereinafter, the obtaining of the time domain attribute information is described with reference to FIG. 4.

FIG. 4 is a diagram illustrating a transformation model according to an example embodiment.

Referring to FIG. 4, the transformation model may include a neural network layer 430, and the neural network layer 430 may include a plurality of neural network layers (e.g., a first neural network layer 431, a second neural network layer 432, a third neural network layer 433, a fourth neural network layer 434, and a fifth neural network layer 435). The transformation model to which a positional and structural feature 410 and a time 420 are input may output time domain attribute information 440.

The transformation model (e.g., a Gaussian transformation model) may compute change attribute information based on position information (e.g., position-encoded position information r(p)), a time variable (e.g., a position-encoded time variable r(t)), and structural feature information (e.g., a feature). The change attribute information may be expressed as Equation 1 below.

$$( Δ x , Δ y , Δ z , {a}_{1}^{′} , {a}_{2}^{′} , Δ sx , Δ sy , Δ sz ) = {F}_{θ} ( r ( {x}_{0} , {y}_{0} , {z}_{0} ) , r ( t ) , feature ) \qquad [ Equation 1 ]$$

The feature denotes the structural feature information, and r denotes a positional encoding function. Θ may represent a network parameter (e.g., a weight or a bias) of the transformation model (or a transformation field). The positional encoding function r may be expressed as Equation 2 below.

$$r ( x ) = {( sin ( {2}^{k} π x ) , cos ( {2}^{k} π x ) )}_{k = 0}^{L - 1} \qquad [ Equation 2 ]$$

In Equation 2, x denotes a position in the transformation field (e.g., p(x0, y0, z0)) or a time input parameter (e.g., t), and L denotes a dimensionless value related to a frequency domain component and may denote a logarithm of a sin-cos pair. For example, for position coordinates (e.g., p(x0, y0, z0)), L may be “10,” and for the time variable t, L may be “6.” The frequency may increase as L increases, and Equation 2 may explain a detail for a higher frequency. In Equations 1 and 2, the inputs of the transformation model may be the position-encoded position information (e.g., r(p)) and the position-encoded time variable (e.g., r(t)). The output of the transformation model may include position change information (Δx, Δy, Δz), rotation change information (a₁′, a₂′), and size change information (Δsx, Δsy, Δsz), and each piece of information may include the time variable t.

A structure of the transformation model (e.g., a feature decoding structure or a structure of a decoder and/or the like) may include the five neural network layers, that is, the first to fight neural network layers 431, 432, 433, 434, and 435. The position information (e.g., the position-encoded position information r(p)), the structural feature information, and the time variable (e.g., the position-encoded time variable r(t)) may be input to the transformation model. An output of one layer may be an input to another layer. For example, an output of the second neural network layer 432 may be an input to the third neural network layer 433. The transformation model may include a cross-layer connection that connects the positional and structural feature 410 information to an intermediate neural network layer (e.g., the second neural network layer 432). The transformation model may not include a cross-layer connection, or may include a cross-layer connection between different layers (e.g., between the third neural network layer 433 and the fifth neural network layer 435).

The output of the transformation model may be the time domain attribute information 440 including the position change information (Δx, Δy, Δz), the rotation change information (a₁′,a₂′), and the size change information (Δsx, Δsy, Δsz) based on the time t. Since a₁′ and a₂′ of the rotation change information may each include three parameters, the output may have a total of 12 parameters, a last layer may have 12 neurons, and other layers may have 256 neurons. The number of layers and the number of neurons in a neural network structure may be any other numbers. The transformation model may be implemented via one or more neural network models when the transformation model may implement a corresponding computational function.

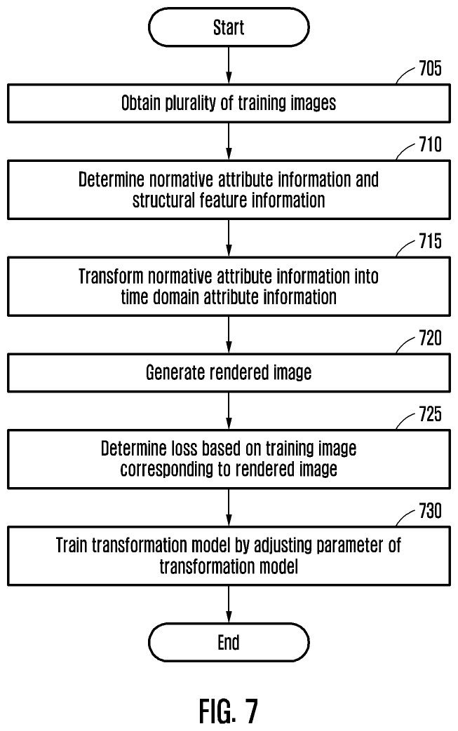

The network parameter (e.g., a weight or a bias) of the transformation model may be adjusted during a process of training the transformation model. The tuning of the parameters will be described in more detail with reference to FIG. 7.

The transformation model may output the time-based change attribute information by performing a Gaussian transformation on the normative attribute information. For example, the time domain attribute information 440 based on time of each 3D Gaussian point may be determined based on the normative attribute information and time-based change attribute information of each 3D Gaussian point in the time-domain space. The position information of the time domain attribute information 440 may be expressed as Equation 3 below.

$${x}_{t} = {x}_{0} + Δ x \qquad [ Equation 3 ]$$

$${y}_{t} = {y}_{0} + Δ y$$

$${z}_{t} = {z}_{0} + Δ z$$

xₜ denotes a coordinate of the 3D Gaussian point in an x-direction at the time point t in the time-domain space, yₜ denotes a coordinate of the 3D Gaussian point in a y-direction at the time point t in the time-domain space, and zₜ denotes a coordinate of the 3D Gaussian point in a z-direction at the time point t in the time-domain space.

The size information of the time domain attribute information 440 may be expressed as Equation 4 below.

$${sx}_{t} = sx + Δ sx \qquad [ Equation 4 ]$$

$${sy}_{t} = sy + Δ sy$$

$${sz}_{t} = sz + Δ sz$$

sxₜ denotes a size of the 3D Gaussian point in the x-direction at the time point t in the time-domain space, syₜ denotes a size of the 3D Gaussian point in the y-direction at the time point t in the time-domain space, and szₜ denotes a size of the 3D Gaussian point in the z-direction at the time point t in the time-domain space.

The rotation information of the time domain attribute information 440 may be expressed as Equation 5 below.

$$R = 6 DR 2 Matrix ( {a}_{1}^{′} , {a}_{2}^{′} ) \times 6 DR 2 Matri x ( {a}_{1} , {a}_{2} ) \qquad [ Equation 5 ]$$

The 6DR2Matrix function transforms a 6-dimensional continuous rotation representation into a rotation matrix of the rotation group SO(3) and may be expressed as Equations 6 and 7 below.

$$6 DR 2 Matrix ( [ \begin{matrix}\vert & \vert \\ {a}_{1} & {a}_{2} \\ \vert & \vert\end{matrix} ] ) = [ \begin{matrix}\vert & \vert & \vert \\ {b}_{1} & {b}_{2} & {b}_{3} \\ \vert & \vert & \vert\end{matrix} ] \qquad [ Equation 6 ]$$

$${b}_{i} = {[ \{ \begin{matrix}N ( {a}_{1} ) & i = 1 \\ N ( {a}_{2} - ( {b}_{1} \cdot {a}_{2} ) {b}_{1} ) & i = 2 \\ {b}_{1} \times {b}_{2} & i = 3\end{matrix} ]}^{T} \qquad [ Equation 7 ]$$

Vertical lines of Equation 6 indicate that a corresponding vector is a column vector (e.g., a₁ is a column vector with three rows), and N of Equation 7 indicates a normalization function.

FIG. 5 is a block diagram illustrating an image processing apparatus according to an example embodiment.

Referring to FIG. 5, an image processing apparatus 500 may include an image obtainer 510, an attribute determiner 520, a transformation processor 530, and an image renderer 540.

The image obtainer 510 may obtain a plurality of images. For example, the image obtainer 510 may obtain the plurality of images from an input image sequence. The plurality of images may include a plurality of monocular images captured at different times and/or at different locations.

The attribute determiner 520 may determine normative attribute information and structural feature information of a normative space of a point cloud included in the plurality of images. The attribute determiner 520 may determine the normative attribute information in a normative space of each 3D Gaussian point in a 3D Gaussian point set corresponding to the point cloud, and the normative attribute information may include at least one of position information, rotation information, and size information of the 3D Gaussian point.

The attribute determiner 520 may obtain the structural feature information in the normative space of the point cloud included in a plurality of input images. The attribute determiner 520 may extract features of the 3D Gaussian point based on the position information of the 3D Gaussian point and fuse the features to obtain the structural feature information of the 3D Gaussian point. For example, the attribute determiner 520 may obtain feature information of a voxel by extracting a feature of the 3D Gaussian point using the position information of the 3D Gaussian point and a voxel feature extraction model (e.g., U-Net). The attribute determiner 520 may extract a feature of the 3D Gaussian point using the position information of the 3D Gaussian point and a first neural network model and obtain point feature information of the 3D Gaussian point. The attribute determiner 520 may obtain structural feature information of the 3D Gaussian point by fusing features using the feature information of the voxel (e.g., structural information of the voxel), the point feature information of the 3D Gaussian point, and a second neural network model.

The transformation processor 530 may transform the normative attribute information into time domain attribute information of a time-domain space, based on the structural feature information and a transformation model that is based on a neural network. The transformation processor 530 may transform the normative attribute information into the time domain attribute information of the point cloud in the time-domain space, using the structural feature information and a transformation network. The transformation processor 530 may determine time domain attribute information of the 3D Gaussian point by performing feature decoding of the transformation network, based on the normative attribute information and the structural feature information of the 3D Gaussian point.

For example, the transformation processor 530 may input the normative attribute information and the structural feature information of the 3D Gaussian point to the transformation network and determine the time domain attribute information of the 3D Gaussian point by performing feature decoding. The transformation processor 530 may determine time-based change attribute information for the 3D Gaussian point by performing Gaussian transformation on the normative attribute information, using a third neural network model. The transformation processor 530 may determine time-based time domain attribute information for the 3D Gaussian point, based on the normative attribute information and the time-based change attribute information of the 3D Gaussian point. The time-based change attribute information may include at least one of position change information, rotation change information, or size change information of the 3D Gaussian point.

The image renderer 540 may generate a rendered image for the plurality of images, based on the time domain attribute information.

The image obtainer 510, the attribute determiner 520, the transformation processor 530, and the image renderer 540 of the image processing apparatus 500 may be implemented as hardware components and/or software components. For example, the image obtainer 510, the attribute determiner 520, the transformation processor 530, and the image renderer 540 may be implemented using a field programmable gate array (FPGA) or an application-specific integrated circuit (ASIC).

FIG. 6 is a block diagram illustrating an image processing apparatus according to an example embodiment.

Referring to FIG. 6, an image processing apparatus 600 may include a processor 620 and a memory 610. The image processing apparatus 600 may correspond to the image processing apparatus 500 of FIG. 5.

The processor 620 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an ASIC, an FPGA, or any combination thereof.

The processor 620 may determine normative attribute information and structural feature information of a normative space of a point cloud included in a plurality of images. For example, the processor 620 may determine normative attribute information of a normative space of 3D Gaussian points included in a 3D Gaussian point set corresponding to the point cloud. The processor 620 may obtain structural feature information of each 3D Gaussian point by extracting features of a 3D Gaussian point based on position information of each 3D Gaussian point and fusing the extracted features.

The processor 620 may obtain structural information of a voxel by extracting a grid feature for the 3D Gaussian point using the position information of the 3D Gaussian point and a voxel feature extraction model. The processor 620 may obtain point feature information of the 3D Gaussian point by extracting a feature for the 3D Gaussian point using the position information of the 3D Gaussian point and a first neural network model and may obtain the structural feature information of the 3D Gaussian point by fusing the extracted features for the 3D Gaussian point using the structural information of the voxel, the point feature information of the 3D Gaussian point, and a second neural network model.

The processor 620 may transform the normative attribute information into time domain attribute information of a time-domain space, based on the structural feature information and a transformation model that is based on a neural network, and may generate a rendered image for the plurality of images, based on the time domain attribute information. For example, the processor 620 may determine time domain attribute information of each 3D Gaussian point by performing feature decoding, using the transformation model, based on the structural feature information and the normative attribute information of each 3D Gaussian point.

The processor 620 may determine time-based change attribute information for each 3D Gaussian point by performing Gaussian transformation on the normative attribute information using the structural feature information and the transformation model. The processor 620 may determine time-based time domain attribute information for each 3D Gaussian point, based on the normative attribute information and the time-based change attribute information of each 3D Gaussian point.

The memory 610 may store instructions executable by the processor 620. The instructions executable by the processor 620 may, when executed by the processor 620, cause the processor 620 to perform an image processing method and/or a training method of the transformation model according to one or more example embodiments. The memory 610 may be integrated with the processor 620. For example, a random-access memory (RAM) or a flash memory may be arranged in an integrated circuit microprocessor or the like. In addition, the memory 610 may include a separate device, such as an external disk drive, a storage array, or other storage devices that may be used by a database system. The memory 610 and the processor 620 may be operatively integrated or may communicate with each other through an input/output (I/O) port or a network connection, and the processor 620 may read a file stored in the memory 610. The memory 610 may include a computer-readable storage medium configured to store instructions, and the instructions stored in the memory 610 may, when executed by the processor 620, prompt at least one processor to execute an image processing method and/or a training method of an image processing model according to one or more example embodiments.

Examples of a non-transitory computer-readable storage medium may include a read-only memory (ROM), a random-access programmable read-only memory (PROM), an electrically erasable programmable read-only memory (EEPROM), a RAM, a dynamic RAM (DRAM), a static RAM (SRAM), a flash memory, a non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, a hard disk drive (HDD), a solid state drive (SSD), a card memory (e.g., a multimedia card, a secure digital (SD) card, or an extreme digital (XD) card), magnetic tape, a floppy disk, a magneto-optical data storage device, an optical data storage device, a hard disk, a solid-state disk, and other devices.

The other devices may store computer programs and any associated data, data files, and data structures in a non-transitory manner and provide the computer programs and any associated data, data files, and data structures to a processor or computer, and the processor or computer may execute the computer programs. The computer programs in the non-transitory computer-readable storage medium may run in an environment deployed in a computer device such as a client, a host, a proxy device, a server, and/or the like. In an example, the computer programs and any associated data, data files and data structures may be distributed over network-coupled computer systems, and the computer programs and any associated data, data files, and data structures may be stored, accessed, and/or executed in a distributed fashion by one or more processors or computers.

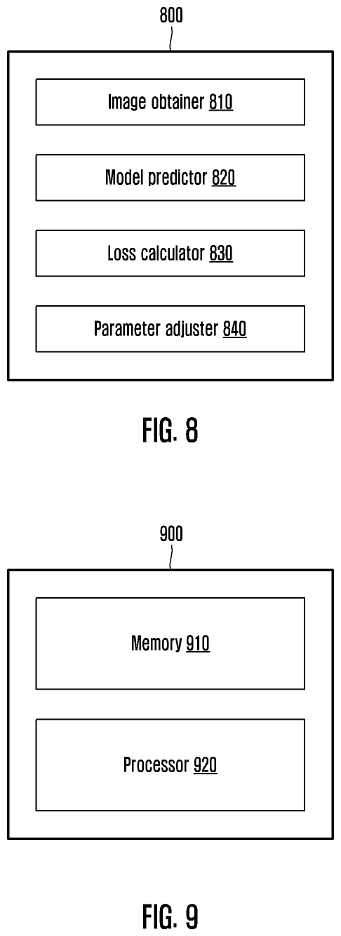

FIG. 7 is a flowchart illustrating a training method for training a transformation model, according to an example embodiment. Operations of the training method may be performed by a training apparatus (e.g., a training apparatus 800 of FIG. 8).

In operation 705, the training apparatus may obtain a plurality of training images. The plurality of training images obtained by the training apparatus may include two or more images among at least one of images captured at different times and images captured at different locations. The training apparatus may obtain the plurality of training images from various data sets (e.g., synthetic data sets of “Hell Warrior,” “Mutant,” “Hook,” “Bounding Balls,” “T-Rex,” “Stand Up,” “Jumping Jacks,” and “Lego”).

In operation 710, the training apparatus may determine normative attribute information and structural feature information. The training apparatus may determine normative attribute information and structural feature information of a normative space of point clouds included in the plurality of training images.

In operation 715, the training apparatus may transform the normative attribute information into time domain attribute information.

The training apparatus may transform the normative attribute information into the time domain attribute information of a time-domain space, based on the structural feature information and a transformation model that is based on a neural network. For example, the training apparatus may determine normative attribute information in a normative space of 3D Gaussian points of a 3D Gaussian point set corresponding to a point cloud. At least one of the normative attribute information and the time domain attribute information may include at least one of position information, rotation information, and size information of each 3D Gaussian point. The training apparatus may include an operation of determining the normative attribute information in the normative space of the 3D Gaussian points of the 3D Gaussian point set corresponding to the point cloud.

In operation 720, the training apparatus may generate a rendered image. The training apparatus may generate a rendered image for the plurality of training images, based on the time domain attribute information.

In operation 725, the training apparatus may determine a loss based on a training image corresponding to a rendered image. The training apparatus may determine the loss based on the generated rendered image and the training image, among the plurality of training images, corresponding to the rendered image. For example, the training apparatus may calculate the loss based on the generated rendered image and the training image (e.g., a ground truth (GT) image), among the plurality of training images, corresponding to the rendered image. The training apparatus may arbitrarily select a specific viewpoint for each training and may generate a rendered image corresponding to the viewpoint using the transformation model.

The training apparatus may calculate the loss based on the generated rendered image and the GT image. The training apparatus may calculate the loss by comparing the rendered image of the image processing at a specific viewpoint with the corresponding GT image at the specific viewpoint that is already known. A loss may be expressed as Equation 8 below.

$$ℒ = {( \overline{C} - C )}^{2} + SSIM ( \overline{C} , C ) \qquad [ Equation 8 ]$$

[symbol] denotes the loss, C̅ denotes a rendered image, and C denotes a GT image corresponding to the rendered image, and SSIM indicates a function that calculates structural similarity. For example, a GT image may be an image known from the training images.

In operation 730, the training apparatus may train the transformation model by adjusting a parameter of the transformation model based on the calculated loss.

The training apparatus may iterate adjusting a parameter of the transformation model until the loss calculated in operation 725 satisfies a predetermined condition or until a predetermined number of iterations is reached. For example, when the loss calculated in operation 725 is greater than or equal to a threshold value, the training apparatus may iterate parameter adjustment and perform iterative image processing until the calculated loss becomes less than the threshold value. The parameter may include, but is not limited to, a parameter related to the voxel feature extraction model (e.g., U-Net) used to train the transformation model, a parameter of the neural network model (e.g., the first neural network model or the second neural network model), a parameter of the transformation model, and/or the like.

The time domain attribute information obtained in the iterative process of parameter adjustment and image processing (hereinafter, referred to as an iterative processing process) may be mapped again to the normative space and transformed back into normative attribute information to be used in subsequent iterative processing. The normative attribute information of the normative space generated in each iterative processing process may be stored or recorded to be used in subsequent iterative processes.

The training apparatus may determine an initialized point cloud and corresponding initialized normative attribute information in an operation of determining normative attribute information according to operation 710 and may determine normative attribute information that may be stored, recorded, and/or fed back from the time-domain attribute information.

With respect to the method of training the transformation model, adjustment of a specific parameter based on a loss function may be performed in a similar manner to a model training method in the related art, as long as an input, an output, and/or a specific built-in parameter conform to the claimed scope of protection.

Based on the generated rendered image and the GT image, training may be performed using semi-supervised, fully supervised, and/or other existing training methods. Training may mean applying a training algorithm to a plurality of pieces of data (e.g., attribute information, an individual structure, or a model parameter) that may be trained to form a predefined operation rule or artificial intelligence model having desired characteristics. Training may be performed on a device itself, depending on the embodiment, or may be performed through a separate server/apparatus/system.

The training apparatus may determine gradient information of a 3D Gaussian point of the 3D Gaussian point set corresponding to the point cloud, and may determine whether to perform a density control operation, which changes a number of 3D Gaussian points, based on the time domain attribute information and the gradient information. At least one of the normative attribute information and the time domain attribute information used for training may include at least one of position information, rotation information, and size information of each 3D Gaussian point.

The training apparatus may perform adaptive density control on the 3D Gaussian point prior to image rendering. When reconstructing a static scene, the transformation model may return a gradient value for each 3D Gaussian point for each training round, and when the gradient value is greater than a predefined gradient threshold value, the training apparatus may perform a density control operation on the 3D Gaussian point. The density control operation may include a replication operation and a splitting operation. The density control operation may include, but is not limited to, changing the number of 3D Gaussian points (e.g., a number of point clouds or sets of 3D Gaussian points), for example, changing the number of 3D Gaussian points by a replication operation or a division operation. When the gradient value is greater than the gradient threshold value and a size of the 3D Gaussian point is less than or greater than a size threshold size, a replication operation or a division operation may be performed on the 3D Gaussian point and may be performed based on a time variable.

In the iterative processing process, the training apparatus may project a 3D Gaussian point of image processing that uses a transformation model onto an image plane (e.g., projecting a 3D Gaussian point having 3D coordinate values (e.g., (x, y, z)) onto a 2D Gaussian point having 2D coordinates (e.g., (x, y, 0))), calculate a 2D coordinate gradient value based on the coordinates of the 2D Gaussian point on the image plane, and determine the 2D coordinate gradient value to be the gradient value of the 3D Gaussian point.

In the iterative process, the training apparatus may determine the gradient value of the 3D Gaussian point. It is described that the gradient value of the 3D Gaussian point is determined based on the 2D coordinate gradient value. However, embodiments are not limited thereto.

In the iterative processing process for training the transformation model, the gradient value may be reflected in the 3D Gaussian point. The training apparatus may determine whether to perform a density control operation, based on time domain attribute information and gradient information of a specific time point (e.g., a current time point). For example, the training apparatus may train the transformation model every 100 iterative processing processes. In this case, the training apparatus may determine whether to perform a density control operation every 100 iterative processing processes. The training apparatus may determine whether to perform a density control operation, based on a size of an averaged gradient value and time domain attribute information of the 3D Gaussian point of a specific time point (e.g., a current time point). As described above, the training apparatus may determine whether to perform a density control operation at a specific time point in the time-domain space rather than in the normative space.

When a condition for performing a density control operation is satisfied (e.g., the gradient value is greater than or equal to the gradient threshold value, and the size of the 3D Gaussian point at a specific time point is greater than or equal to the size threshold size), the training apparatus may perform a density control operation including a replication operation or a division operation.

In order to perform a density control operation on a 3D Gaussian point in the normative space, the same density control operation performed on 3D Gaussian points in the normative space may be performed on a 3D Gaussian point corresponding to the normative space and a specific time point. For example, when the training apparatus performs a replication operation on a 3D Gaussian point, the replication operation in the normative space may be completely identical to a replication operation in the time-domain space, and the replication operation may be performed in the time-domain space or directly in the normative space.

When the training apparatus performs a division operation on a 3D Gaussian point, the division operation in the normative space may not be the same as a division operation in the time-domain space. Thus, the division operation may be performed in the time-domain space, and a division operation result may be mapped back to the normative space. The division operation may be performed indirectly in the normative space through a mapping process.

The training apparatus may perform more effective image processing by changing the number of 3D Gaussian points through density control.

FIG. 8 is a block diagram illustrating a training apparatus according to an example embodiment.

Referring to FIG. 8, the training apparatus 800 may include an image obtainer 810, a model predictor 820, a loss calculator 830, and a parameter adjuster 840.

The image obtainer 810 may obtain a plurality of training images. For example, the image obtainer 810 may obtain the plurality of training images from an input training image sequence. The plurality of training images may include a plurality of monocular training images captured at different times and/or at different locations.

The model predictor 820 may generate a rendered image corresponding to a training image, for the plurality of training images, using a transformation model. For example, the model predictor 820 may determine normative attribute information and structural feature information of a normative space of point clouds included in the plurality of training images, transform the normative attribute information into time domain attribute information of a time-domain space, based on the structural feature information and a transformation model that is based on a neural network, and generate a rendered image for the plurality of training images, based on the time domain attribute information. The description with reference to FIG. 4 may be referred to for the transformation model used for the model predictor 820 and a repeated description thereof is omitted.

The loss calculator 830 may calculate a loss based on a rendered image and a training image, among the plurality of training images, corresponding to the rendered image.

The loss calculator 830 may calculate the loss based on the generated rendered image and the training image (e.g., a GT image), among the plurality of training images, corresponding to the rendered image. The loss calculator 830 may calculate the loss by comparing the rendered image of the image processing at a specific viewpoint with the corresponding GT image at the specific viewpoint that is already known. As shown in Equation 8 above, the loss may be expressed using a function in which C denotes a rendered image, C denotes a GT image corresponding to the rendered image, and SSIM indicates a function that calculates structural similarity.

The parameter adjuster 840 may train the transformation model by adjusting a parameter of the transformation model based on the loss.

The parameter adjuster 840 may iterate adjusting a parameter of the transformation model until the calculated loss satisfies a predetermined condition or until a predetermined number of iterations is reached. For example, when the calculated loss is greater than or equal to a threshold value, the parameter adjuster 840 may iterate parameter adjustment and perform iterative image processing until the calculated loss becomes less than the threshold value. The parameter may include, but is not limited to, a parameter related to the voxel feature extraction model (e.g., U-Net) used to train the transformation model, a parameter of the neural network model, a parameter of the transformation model, and/or the like.

The parameter adjuster 840 may determine gradient information of a 3D Gaussian point of a 3D Gaussian point set corresponding to the point cloud, and may determine whether to perform a density control operation based on the time domain attribute information and the gradient information. The density control operation may include changing a number of 3D Gaussian points.

The image obtainer 810, the model predictor 820, the loss calculator 830, and the parameter adjuster 840 of the training apparatus 800 may be implemented as hardware components and/or software components. For example, the image obtainer 810, the model predictor 820, the loss calculator 830, and the parameter adjuster 840 may be implemented using an FPGA or an ASIC.

FIG. 9 is a block diagram illustrating a training apparatus according to an example embodiment.

Referring to FIG. 12, a training apparatus 900 may include a processor 920 and a memory 910. The training apparatus 900 may correspond to the training apparatus 800 of FIG. 8.

The processor 920 may include a CPU, a GPU, an NPU, an MPU, a DPU, a VPU, a video processor, an image processor, a display processor, a microprocessor, a processor core, a multi-core processor, an ASIC, an FPGA, or any combination thereof.

The processor 920 may determine normative attribute information and structural feature information of a normative space of point clouds included in a plurality of training images. For example, the processor 920 may determine normative attribute information in a normative space of 3D Gaussian points included in a 3D Gaussian point set corresponding to the point cloud. At least one of the normative attribute information and the time domain attribute information may include at least one of position information, rotation information, and size information of each 3D Gaussian point. The processor 920 may determine gradient information of a 3D Gaussian point of the 3D Gaussian point set corresponding to the point cloud, and may determine whether to change a number of 3D Gaussian points, based on the time domain attribute information and the gradient information.

The processor 920 may transform the normative attribute information into the time domain attribute information of a time-domain space, based on the structural feature information and a transformation model that is based on a neural network, and may generate a rendered image for the plurality of training images, based on the time domain attribute information.

The processor 920 may determine a loss based on the generated rendered image and a training image, among the plurality of training images, corresponding to the rendered image, and may train the transformation model by adjusting a parameter of the transformation model based on the determined loss.

The memory 910 may store instructions executable by the processor 920. The instructions executable by the processor 920 may, when executed by the processor 920, cause the processor 920 to perform an image processing method or a training method of the transformation model. The memory 910 may be integrated with the processor 920. For example, RAM or flash memory may be arranged in an integrated circuit microprocessor or the like. In addition, the memory 910 may include a separate device, such as an external disk drive, a storage array, or other storage devices that may be used by a database system. The memory 910 and the processor 920 may be operatively integrated or may communicate with each other through an I/O port or a network connection and the processor 920 may read a file stored in the memory 910. The memory 910 may be a computer-readable storage medium storing instructions, and the instructions stored in the memory 910 may, when executed by the processor 920, prompt at least one processor to execute an image processing method or a training method of an image processing model.

The image processing method and apparatus and a training method and apparatus for an image processing model may model a dynamic scene for continuous time and determine a mapping transformation relationship between the normative space and the time-domain space to implement an accurate change and motion prediction and save storage overhead. The image processing method and apparatus and the training method and apparatus for an image processing model may also model a dynamic scene in which time and a location (or a viewpoint) simultaneously change. For example, the image processing method and apparatus and the training method and apparatus for an image processing model may generate images rendered at different times and from different angles for an input image. The image processing method and apparatus and the training method and apparatus for an image processing model may implement new viewpoint image synthesis based on a monocular image or video.

Technologies related to image processing are being developed with advancement of computer technology. For example, a 3D Gaussian splatting-based algorithm for real-time rendering of a radiance field requires a short training time and may achieve a state-of-the-art visual effect. In addition, the 3D Gaussian splatting-based algorithm may synthesize new viewpoint images in high quality (e.g., a 1080p resolution) and real-time (e.g., frames per second (fps) greater than or equal to 30 fps) based on multiple photos and/or multiple videos.

3D Gaussian-based image synthesis technology may implement a high-resolution image through a real-time rendering method using the splatting algorithm. The 3D Gaussian-based image synthesis technology may perform scene representation from a sparse point generated during a camera calibration process to a 3D Gaussian point. The 3D Gaussian-based image synthesis techniques may optimize a scene by maintaining ideal properties of continuous radiance fields and thus avoiding an unnecessary calculation in an empty space. The 3D Gaussian-based image synthesis technology may accurately represent a scene through interleaving optimization and density control of a 3D Gaussian point for anisotropic covariance optimization. The 3D Gaussian-based image synthesis technology may include a fast visibility-aware rendering algorithm that supports anisotropic splatting and enables real-time rendering while increasing training speed.

Conventional image processing technology may include modeling technology for a static scene and modeling technology for a dynamic scene. The related art dynamic scene modeling technology involves a process of training 150 time steps and an experiment that uses synchronized multi-view videos (e.g., 27 training cameras and 4 test cameras) of a dataset to solve new-view synthesis and six degrees of freedom (6DOF) tracking of a dynamic scene. The related art dynamic scene modeling technology only connects static scenes across multiple time steps and thus is still temporally discontinuous and cannot implement dynamic scenes in truly continuous time. In addition, such a discontinuous dynamic scene modeling method consumes a lot of storage resources since data needs to be stored at each time step.

To solve the issues of the related art image processing technology, the image processing method and apparatus and the training method and apparatus for an image processing model provide image processing technology for modeling a dynamic scene in continuous time by introducing a time variable. The image processing method and apparatus and the training method and apparatus for an image processing model may model a dynamic scene in continuous time by transforming image data in a normative space into data in a time-domain space and describing a motion of the image data and/or a process of change in the motion over time in the time-domain space. The image processing method and apparatus and a training method and apparatus for an image processing model may model a dynamic scene for continuous time and determine a mapping transformation relationship between the normative space and the time-domain space to implement an accurate change and motion prediction and save storage overhead. In addition, the image processing method and apparatus and the training method and apparatus of the image processing model may perform modeling in a dynamic scene in which time and a location (or a viewpoint) simultaneously change. For example, the image processing method and apparatus and the training method and apparatus for an image processing model may generate a rendered image from a different angle or at a different time from a scene into which an image is input.

The example embodiments described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and/or create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be permanently or temporarily embodied in any type of machine, component, physical or virtual equipment, or computer storage medium or device for the purpose of being interpreted by the processing device or providing instructions or data to the processing device. The software may also be distributed over network-coupled computer systems and the software may be stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include the program instructions, data files, data structures, and/or the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and/or the like. Examples of program instructions include both machine code, such as those produced by a compiler, and files containing higher-level code that may be executed by the computer using an interpreter.

The above-described hardware devices may be configured to act as one or more software modules in order to perform the operations of the above-described embodiments, or vice versa.

Although the examples have been described with reference to the limited number of drawings, it will be apparent to one of ordinary skill in the art that various technical modifications and variations may be made in the examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other examples, and equivalents to the claims are also within the scope of the following claims.

What is claimed is:

1. An image processing apparatus comprising:
a memory configured to store instructions; and
a processor configured to execute the instructions,
wherein, by executing the instructions, the processor is configured to:
determine a normative attribute information and a structural feature information of a normative space of point clouds included in a plurality of images;
transform the normative attribute information into a time domain attribute information of a time-domain space, based on the structural feature information and a transformation model, the transformation model being based on a neural network; and
generate a rendered image for the plurality of images, based on the time domain attribute information.

2. The image processing apparatus of claim 1, wherein the processor is further configured to, in determining the normative attribute information:
determine a normative attribute information of a normative space of three-dimensional (3D) Gaussian points included in a 3D Gaussian point set corresponding to a point cloud, and
wherein at least one of the normative attribute information or the time domain attribute information comprises at least one of a position information, a rotation information, or a size information of each 3D Gaussian point of the 3D Gaussian points.

3. The image processing apparatus of claim 2, wherein the processor is further configured to, in determining the structural feature information:
obtain, for each 3D Gaussian point, a structural feature information of a 3D Gaussian point by extracting features of the 3D Gaussian point based on the position information of the 3D Gaussian point and fusing the extracted features; and
determine a time domain attribute information of each 3D Gaussian point by performing a feature decoding based on the transformation model, the structural feature information of each 3D Gaussian point, and the normative attribute information.

4. The image processing apparatus of claim 3, wherein the processor is configured to, in obtaining the structural feature information of the 3D Gaussian point:
obtain structural information of a voxel by extracting a grid feature for the 3D Gaussian point using the position information of the 3D Gaussian point and a voxel feature extraction model;
obtain point feature information of the 3D Gaussian point by extracting the features of the 3D Gaussian point using the position information of the 3D Gaussian point and a first neural network model; and
obtain the structural feature information of the 3D Gaussian point by fusing the extracted features using the structural information of the voxel, the point feature information of the 3D Gaussian point, and a second neural network model.

5. The image processing apparatus of claim 3, wherein the processor is configured to, in determining the time domain attribute information of each 3D Gaussian point:
determine a time-based change attribute information for each 3D Gaussian point by performing a Gaussian transformation on the normative attribute information using the structural feature information and the transformation model; and
determine the time domain attribute information based on time for each 3D Gaussian point, based on the normative attribute information and the time-based change attribute information of each 3D Gaussian point, and
wherein the time-based change attribute information comprises at least one of a position change information, a rotation change information, or a size change information of each 3D Gaussian point.

6. The image processing apparatus of claim 1, wherein the plurality of images comprises two or more images among at least one of images captured at different times or images captured at different locations.

7. A training apparatus comprising:
a memory configured to store instructions; and
a processor configured to execute the instructions,
wherein the processor, by executing the instructions, is configured to:
determine a normative attribute information and a structural feature information of a normative space of point clouds included in a plurality of training images;
transform the normative attribute information into a time domain attribute information of a time-domain space, based on the structural feature information and a transformation model, the transformation model being based on a neural network;
generate a rendered image for the plurality of training images, based on the time domain attribute information;
determine a loss based on the generated rendered image and a training image, among the plurality of training images, corresponding to the rendered image; and
train the transformation model by adjusting a parameter of the transformation model based on the determined loss.

8. The training apparatus of claim 7, wherein the processor is further configured to:
determine gradient information of a three-dimensional (3D) Gaussian point of a 3D Gaussian point set corresponding to a point cloud; and
determine whether to change a number of 3D Gaussian points based on the time domain attribute information and the gradient information.

9. The training apparatus of claim 8, wherein the processor is further configured to:
determine normative attribute information of a normative space of 3D Gaussian points included in the 3D Gaussian point set corresponding to the point cloud, and
wherein at least one of the normative attribute information or the time domain attribute information comprises at least one of a position information, a rotation information, or a size information of each 3D Gaussian point.

10. An image processing method performed by an image processing apparatus, the image processing method comprising:
obtaining a plurality of images;
determining a normative attribute information and a structural feature information of a normative space of point clouds included in the plurality of images;
transforming the normative attribute information into a time domain attribute information of a time-domain space, based on the structural feature information and a transformation model, the transformation model being based on a neural network; and
generating a rendered image for the plurality of images, based on the time domain attribute information.

11. The image processing method of claim 10, wherein the determining the normative attribute information and the structural feature information comprises:
determining a normative attribute information of a normative space of three-dimensional (3D) Gaussian points of a 3D Gaussian point set corresponding to a point cloud, and
wherein at least one of the normative attribute information or the time domain attribute information comprises at least one of a position information, a rotation information, or size information of each 3D Gaussian point.

12. The image processing method of claim 11, wherein the determining the normative attribute information and the structural feature information comprises:
obtaining, for each 3D Gaussian point, structural feature information of a 3D Gaussian point by extracting features of the 3D Gaussian point based on the position information of the 3D Gaussian point and fusing the extracted features, and
wherein the transforming the time domain attribute information comprises:
determining a time domain attribute information of each 3D Gaussian point by performing feature decoding based on the transformation model, the structural feature information of each 3D Gaussian point, and the normative attribute information.

13. The image processing method of claim 12, wherein the obtaining the structural feature information comprises:
obtaining structural information of a voxel by extracting a grid feature for the 3D Gaussian point using the position information of the 3D Gaussian point and a voxel feature extraction model;
obtaining point feature information of the 3D Gaussian point by extracting the feature of the 3D Gaussian point using the position information of the 3D Gaussian point and a first neural network model; and
obtaining the structural feature information of the 3D Gaussian point by fusing the extracted features using the structural information of the voxel, the point feature information of the 3D Gaussian point, and a second neural network model.

14. The image processing method of claim 13, wherein the determining the time domain attribute information comprises:
determining a time-based change attribute information for each 3D Gaussian point by performing a Gaussian transformation on the normative attribute information using the structural feature information and the transformation model; and
determining the time domain attribute information based on time for each 3D Gaussian point, based on the normative attribute information and the time-based change attribute information of each 3D Gaussian point, and
wherein the time-based change attribute information comprises at least one of a position change information, a rotation change information, or a size change information of each 3D Gaussian point.

15. The image processing method of claim 10, wherein the plurality of images comprises two or more images among at least one of images captured at different times or images captured at different locations.

16. A non-transitory computer-readable storage medium storing instructions that, when executed by a processor, cause the processor to perform the method of claim 10.
